(19) United States
(12) Patent Application Publication
(10) Pub. No.: US 2017/0036500 A1
(43) Pub. Date: Feb. 9, 2017

(54) TIRE PRESSURE DETECTION SYSTEM FOR ABNORMAL VIBRATION

(71) Applicant: JOSN ELECTRONIC CO., LTD., NEW TAIPEI CITY (TW)

(72) Inventor: WEN-CHAO LIAO, NEW TAIPEI CITY (TW)

(21) Appl. No.: 15/042,278

(22) Filed: Feb. 12, 2016

(30) Foreign Application Priority Data
Aug. 5, 2015 (TW) 104125424

(51) Int. Cl. B60C 23/04

(52) U.S. Cl. CPC B60C 23/0488

(57) ABSTRACT

A tyre pressure detection system for abnormal vibration has an abnormal vibration detector disposed in a detection module in a tyre pressure detection system to detect any unusual acceleration of tyres. Upon detecting unusual acceleration and deciding a cause to be loosening tyre or unusual damage, a warning notice is sent to a driver. Thereby the present invention is able to provide a tyre pressure detection system with abnormal vibrations detection system.

### BACKGROUND OF THE INVENTION

1. Field of the Invention

The present invention relates to a tyre pressure detection system for abnormal vibration, particularly to one that has an abnormal detection system to monitor unusual situations of tyre axial acceleration and further alarms a driver upon detection of abnormal vibration of tyres.

2. Description of the Related Art

A car requires tyres with normal pressure values to ensure safety while driving, but tyres are prone to deflate after driving for a while; the temperature difference between days and nights might cause deflation as well. A car running with deflated tyres is highly dangerous, especially for those running in high speed. The tyres may be punctured and this may be a cause to an accident. Therefore, nowadays a tyre pressure system is regarded a standard equipment for cars. On the other hand, when tyres are loosened or wore and tore due to long-term running, the cars tend to appear unusual vibrations during the driving. The drivers would feel fatigue easily, and the suspension system of the cars might be damaged as well; all of which are important factors for safe driving. However, drivers cannot easily notice the minor signals indicating the wear and tear and abnormal status of tyres, especially for those who are still new to driving and those who seldom practice driving.

### SUMMARY OF THE INVENTION

A primary object of the present invention is to provide a tyre pressure detection system for abnormal vibration that is able to detect unusual vibration of tyres during the driving.

To achieve the objects mentioned above, the present invention comprises at least one detection module disposed on at least one tyre of a car and a control module disposed inside the car; wherein the detection module including a microcontroller having at least one microprocessor unit, a pressure detector connected to the microcontroller, an activation detector connected to the microcontroller, a wireless transmitter connected to the microcontroller, an abnormal vibration detector connected to the microcontroller, and a battery connected to the microcontroller, the pressure detector, the wireless transmitter, and the abnormal vibration detector; and the control module including a microprocessor, a display unit connected to the microcontroller, a warning unit connected to the microcontroller, an interface connected to said microcontroller, and a wireless receiver connected to the microcontroller;

whereby the activation detector detects acceleration and vibration of a connected vehicle and actuates the detection module; the pressure detector detects a tyre pressure of a connected tyre and transmits the value to the control module for display and warning; the abnormal vibration detector detects an axial acceleration of the tyre to transmit alarming signals to the control module upon detecting abnormal vibrations of the tyre.

In addition, the activation detector is either a tyre centrifugal acceleration detector or a tyre tangential acceleration detector, or a combination of both, and the abnormal vibration detector is a tyre axial acceleration detector. The activation detector is a switch for tyre centrifugal acceleration or tyre tangential acceleration, or a combination of both. The activation detector is combined with the tyre axial acceleration detector to form a dual-axle or a three-axle acceleration detector. The microcontroller further includes an amplifier, an analog-digital converter, a temperature detector, and a voltage detector. The wireless transmitter is a radio frequency transmitter and the wireless receiver is a radio frequency receiver. The microprocessor unit, amplifier, analog-digital converter, temperature detector, voltage detector, pressure detector, activation detector, abnormal vibration detector, and the wireless transmitter are partially or entirely combined to be a microprocessor. The detection module is either internally or externally arranged.

### BRIEF DESCRIPTION OF THE DRAWINGS

FIG. 1 is a schematic diagram of the present invention installed in a car;

FIG. 2 is a schematic diagram illustrating installation of an internal detection module of the present invention; and

FIG. 3 is a block diagram of structures of the present invention.

### DETAILED DESCRIPTION OF THE PREFERRED EMBODIMENT

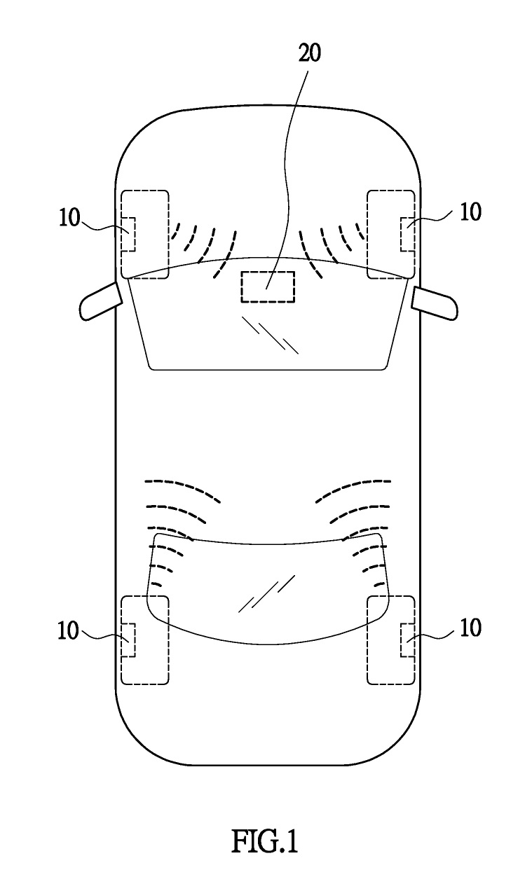

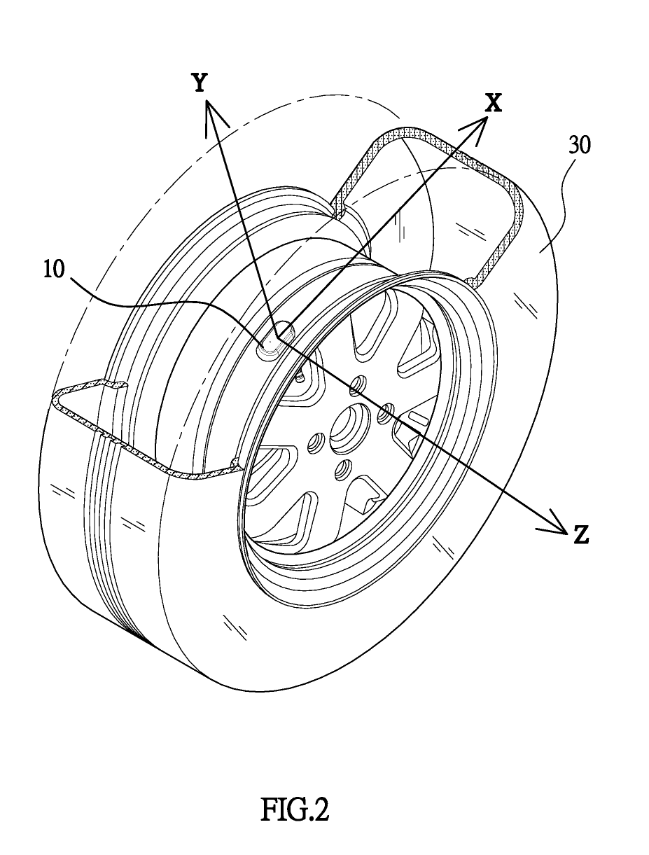

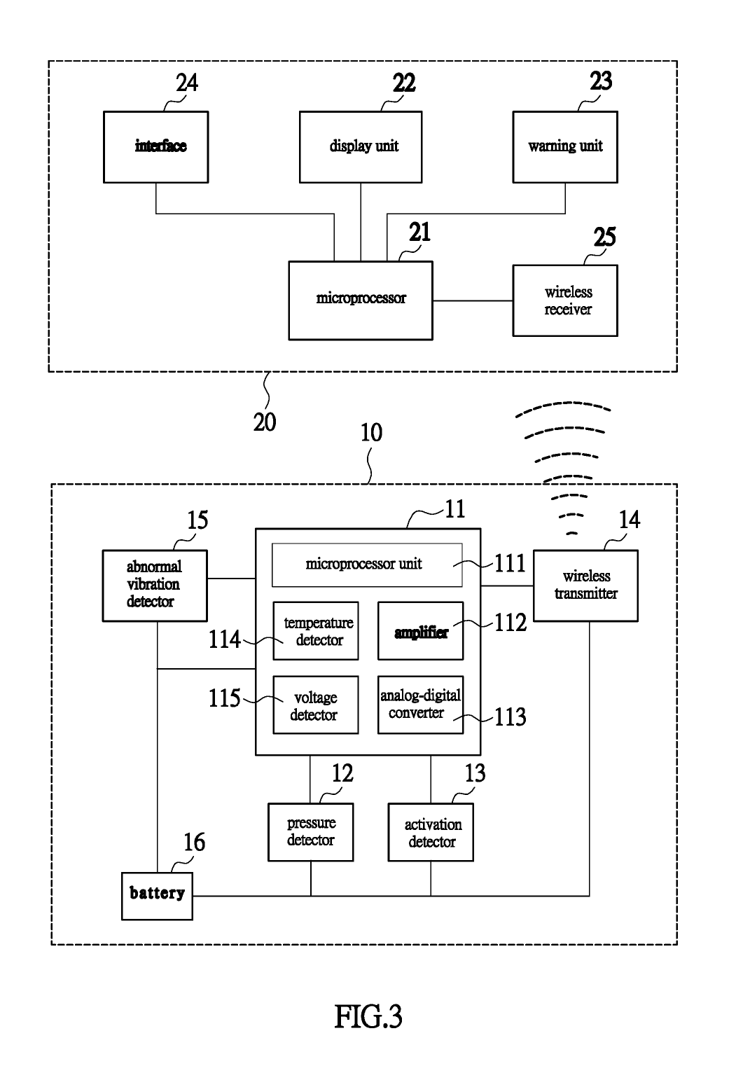

Referring to FIGS. 1-3, in a preferred embodiment, the present invention mainly includes a detection module 10 installed for a tyre 30 and a control module 20 to be installed within a car. The detection module 10 can be internally installed as shown in FIG. 2, or it can be externally installed (not shown); the control module 20 has power supply from the car or a battery.

The detection module 10 includes a microcontroller 11, a pressure detector 12 connected to the microcontroller 11, an activation detector 13, a wireless transmitter 14, an abnormal vibration detector 15, and a battery 16.

The microcontroller 11 has at least one microprocessor unit 111 which is preferably to further include an amplifier 112, an analog-digital converter 113, a temperature detector 114, and a voltage detector 115.

The activation detector 13 is connected to the microcontroller 11 for monitoring tyres during the driving; it is either a tyre centrifugal acceleration detector detecting forces along an Y axis, or a tyre tangential acceleration detector detecting forces along an X axis; or it can be a combination of both or a switch of vibration.

The wireless transmitter 14 is connected to the microcontroller 11 and it can be a radio frequency (RF) transmitter. The abnormal vibration detector 15 is connected to the microcontroller 11 for detecting vibration of the tyre 30; it can be a tyre axial acceleration detector detecting forces along a Z axis. The battery 16 is connected to the microcontroller 11, the pressure detector 12, the wireless transmitter 14, and the abnormal vibration detector 13.

In the embodiment, the microprocessor unit 111, the amplifier 112, the analog-digital converter 113, the temperature detector 114, the voltage detector 115, the pressure detector 12, the activation detector 13, the abnormal vibration detector 15, and the wireless transmitter 14 can be partially or entirely combined to be a microprocessor; and the abnormal vibration detector 13 and the abnormal vibration detector 15 can be combined to be a dual-axle or a three-axle acceleration detector.

On the other hand, the control module 20 includes a microprocessor 21, a display unit 22, a warning unit 23, an interface 24, and a wireless receiver 25; among which the microprocessor 21 is connected to every other element for operation, and the wireless receiver 25 can be a RF receiver.

When the present invention is applied to a car, each tyre has a detection module 10 installed for operation. When the car runs on the road, each detection module 10 detects the acceleration or vibration, i.e. rolling status of the tyres, and actuates the detection modules 10 to individually transmit signals to the wireless receiver 25 of the control module 20 via each wireless transmitter 14. The analog signals of tyre pressure and temperature detected by each pressure detector 12 and temperature detector 114 are amplified and converted to digital signals by each amplifier 112 and analog-digital converter 113 to be received and displayed by the display unit 22. Upon detecting any unusual signals, the warning unit 23 would alarm the driver. Meanwhile, each abnormal vibration detector 15 detects an axial acceleration of the tyres, i.e. vibration of the tyres, and transmits alarming signals by the warning unit 23 when detecting abnormal vibrations of the tyres. Also, each voltage detector 115 detects the electricity of each battery 16 and displays the battery percentage thereof.

To sum up, the present invention is able to detect abnormal status of acceleration of tyres by the abnormal vibration detectors 15, and then sends out alarming notice to the driver, making it a tyre pressure detection system together with an abnormal vibration detection function.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A tyre pressure detection system for abnormal vibration, comprising at least one detection module and a control module; wherein
said detection module including a microcontroller having at least one microprocessor unit, a pressure detector connected to said microcontroller, an activation detector connected to said microcontroller, a wireless transmitter connected to said microcontroller, an abnormal vibration detector connected to said microcontroller, and a battery connected to said microcontroller, said pressure detector, said wireless transmitter, and said abnormal vibration detector; and
said control module including a microprocessor, a display unit connected to said microcontroller, a warning unit connected to said microcontroller, an interface connected to said microcontroller, and a wireless receiver connected to said microcontroller;
whereby the activation detector detects acceleration and vibration of a connected vehicle and actuates the detection module; the pressure detector detects a tyre pressure of a connected tyre and transmits the value to the control module for display and warning; the abnormal vibration detector detects an axial acceleration of the tyre to transmit alarming signals to the control module upon detecting abnormal vibrations of the tyre.

2. The tyre pressure detection system for abnormal vibration as claimed in claim 1, wherein the activation detector is either a tyre centrifugal acceleration detector or a tyre tangential acceleration detector, or a combination of both, and the abnormal vibration detector is a tyre axial acceleration detector.

3. The tyre pressure detection system for abnormal vibration as claimed in claim 1, wherein the activation detector is a switch for tyre centrifugal acceleration or tyre tangential acceleration, or a combination of both.

4. The tyre pressure detection system for abnormal vibration as claimed in claim 2, wherein the activation detector is combined with the tyre axial acceleration detector to form a dual-axle or a three-axle acceleration detector.

5. The tyre pressure detection system for abnormal vibration as claimed in claim 1, wherein the microcontroller further includes an amplifier, an analog-digital converter, a temperature detector, and a voltage detector.

6. The tyre pressure detection system for abnormal vibration as claimed in claim 5, wherein the wireless transmitter is a radio frequency transmitter and the wireless receiver is a radio frequency receiver.

7. The tyre pressure detection system for abnormal vibration as claimed in claim 5, wherein the microprocessor unit, the amplifier, the analog-digital converter, the temperature detector, the voltage detector, the pressure detector, the activation detector, the abnormal vibration detector, and the wireless transmitter are partially or entirely combined to be a microprocessor.

8. The tyre pressure detection system for abnormal vibration as claimed in claim 5, wherein the detection module is either internally or externally arranged.
